(19) United States
(12) Patent Application Publication
(10) Pub. No.: US 2016/0288788 A1
(43) Pub. Date: Oct. 6, 2016

(54) GAP-BASED SPEED CONTROL FOR AUTOMATED DRIVING SYSTEM

(71) Applicant: Toyota Motor Engineering & Manufacturing North America, Inc., Erlanger, KY (US)

(72) Inventors: Naoki Nagasaka, Ann Arbor, MI (US); Bunyo Okumura, Ann Arbor, MI (US)

(21) Appl. No.: 14/674,774

(22) Filed: Mar. 31, 2015

(51) Int. Cl. B60W 30/14

(52) U.S. Cl. CPC B60W 30/143

(57) ABSTRACT

An automated driving system and methods are disclosed. The automated driving system includes a perception system associated with an autonomous vehicle. Sensors in communication with the perception system can detect an object of interest. Based on information specific to the environment surrounding the autonomous vehicle, the automated driving system can determine a vehicle path proximate to the object of interest. Based on properties of the object of interest, the automated driving system can determine a preferred gap between the vehicle path and the object of interest. The automated driving system can also determine an actual gap between the vehicle path and the object of interest. Based on the difference between the preferred gap and the actual gap, the automated driving system can determine a speed profile for the autonomous vehicle along the vehicle path and control the autonomous vehicle to follow the vehicle path according to the speed profile.

### BACKGROUND

Fully or highly automated driving systems are designed to operate a vehicle on the road without driver interaction or other external control, for example, self-driving vehicles or autonomous vehicles. A driver of an autonomous vehicle can experience an improved level of comfort if the automated driving system makes driving decisions for the autonomous vehicle in a manner consistent with the driver's own manual control decisions. This is especially true when a perception system associated with the autonomous vehicle detects objects of interest, such as nearby vehicles, areas of road construction, pedestrians, etc. that would typically cause the driver in a manual control scenario to modify driving behaviors proximate to the objects of interest.

Prior art driving systems that react to objects of interest include, for example, adaptive cruise control (ACC) that can modify the speed of a vehicle based on a preceding vehicle. Prior art driving systems also include various distance control systems that can modify the vehicle's planned path to maximize the distance between the vehicle and various objects of interest. However, an automated driving system that implements balanced speed and distance control proximate to objects of interest is needed to better provide a feeling of comfort to the driver and passengers in the autonomous vehicle.

### SUMMARY

Methods and systems for gap-based speed control of automated driving proximate to objects of interest are described below. A perception system associated with an autonomous vehicle can detect an object of interest, such as another vehicle, a pedestrian, or a construction zone. Based on information specific to an environment surrounding the autonomous vehicle, such as road geometry, traffic density, etc., an automated driving system can determine a vehicle path for the autonomous vehicle near the object of interest. Based on properties of the object of interest, such as relative speed, size, and type, the automated driving system can determine a preferred gap between the vehicle path and the object of interest to insure driver comfort as well as the actual gap that will occur based on any constraints for the vehicle path. Based on a difference between the preferred gap and the actual gap, the automated driving system can select a speed profile for the autonomous vehicle along the vehicle path and control the autonomous vehicle to follow the vehicle path according to the speed profile.

In one implementation, an automated driving system is disclosed. The automated driving system includes a perception system associated with an autonomous vehicle and a computing device in communication with the perception system. The computing device includes one or more processors for controlling operations of the computing device and a memory for storing data and program instructions used by the one or more processors. The one or more processors are configured to execute instructions stored in the memory to: detect, using the perception system, an object of interest; determine, based on information specific to an environment surrounding the autonomous vehicle, a vehicle path proximate to the object of interest; determine, based on properties of the object of interest, a preferred gap between the vehicle path and the object of interest; determine an actual gap between the vehicle path and the object of interest; determine, based on a difference between the preferred gap and the actual gap, a speed profile for the autonomous vehicle along the vehicle path; and send a command, to one or more vehicle systems, to control the autonomous vehicle to follow the vehicle path using the speed profile.

In another implementation, a computer-implemented method of automated driving is disclosed. The method includes detecting, using a perception system associated with an autonomous vehicle, an object of interest; determining, based on information specific to an environment surrounding the autonomous vehicle, a vehicle path proximate to the object of interest; determining, based on properties of the object of interest, a preferred gap between the vehicle path and the object of interest; determining an actual gap between the vehicle path and the object of interest; determining, based on a difference between the preferred gap and the actual gap, a speed profile for the autonomous vehicle along the vehicle path; and sending a command, to one or more vehicle systems, to control the autonomous vehicle to follow the vehicle path according to the speed profile.

In another implementation, a computing device is disclosed. The computing device includes one or more processors for controlling operations of the computing device and a memory for storing data and program instructions used by the one or more processors. The one or more processors are configured to execute instructions stored in the memory to: detect, using a perception system associated with an autonomous vehicle, an object of interest; determine, based on information specific to an environment surrounding the autonomous vehicle, a vehicle path proximate to the object of interest; determine, based on properties of the object of interest, a preferred gap between the vehicle path and the object of interest; determine an actual gap between the vehicle path and the object of interest; determine, based on a difference between the preferred gap and the actual gap, a speed profile for the autonomous vehicle along the vehicle path; and send a command, to one or more vehicle systems, to control the autonomous vehicle to follow the vehicle path using the speed profile.

### BRIEF DESCRIPTION OF THE DRAWINGS

The description herein makes reference to the accompanying drawings wherein like reference numerals refer to like parts throughout the several views, and wherein:

FIG. 1 is a block diagram of a computing device;

FIG. 2 is a schematic illustration of an autonomous vehicle including the computing device of FIG. 1;

FIG. 3 shows a vehicle path for the autonomous vehicle of FIG. 2 proximate to another vehicle in an adjacent lane;

FIG. 4 shows a speed profile for the autonomous vehicle of FIG. 2 along the vehicle path of FIG. 3;

FIG. 5 shows a vehicle path for the autonomous vehicle of FIG. 2 proximate to a construction zone;

FIG. 6 shows a speed profile for the autonomous vehicle of FIG. 2 along the vehicle path of FIG. 5;

FIG. 7 shows a vehicle path for the autonomous vehicle of FIG. 2 proximate a plurality of vehicles in adjacent lanes;

FIG. 8 shows a speed profile for the autonomous vehicle of FIG. 2 along the vehicle path of FIG. 7; and

FIG. 9 is a logic flowchart of a gap and speed profile determination process performed by the automated driving system.

### DETAILED DESCRIPTION

An automated driving system for an autonomous vehicle is disclosed. The automated driving system can control the autonomous vehicle to follow a vehicle path. The vehicle path can be selected based both on information specific to the environment surrounding the autonomous vehicle, such as traffic density, road geometry, etc., and on objects of interest that the autonomous vehicle may pass on the vehicle path, such as other vehicles, pedestrians, and construction zones. A distance optimized for driver comfort between the vehicle path and a given object of interest can be calculated in terms of a preferred gap. Similarly, the actual distance between the selected vehicle path and the given object of interest can be calculated in terms of an actual gap. If the actual gap is smaller than the preferred gap, that is, if the driver of the autonomous vehicle could be uncomfortable with the proximity of the object of interest during a passing maneuver on the selected vehicle path, the autonomous vehicle can be controlled to follow a speed profile where the autonomous vehicle slows down while it passes the object of interest to improve driver comfort.

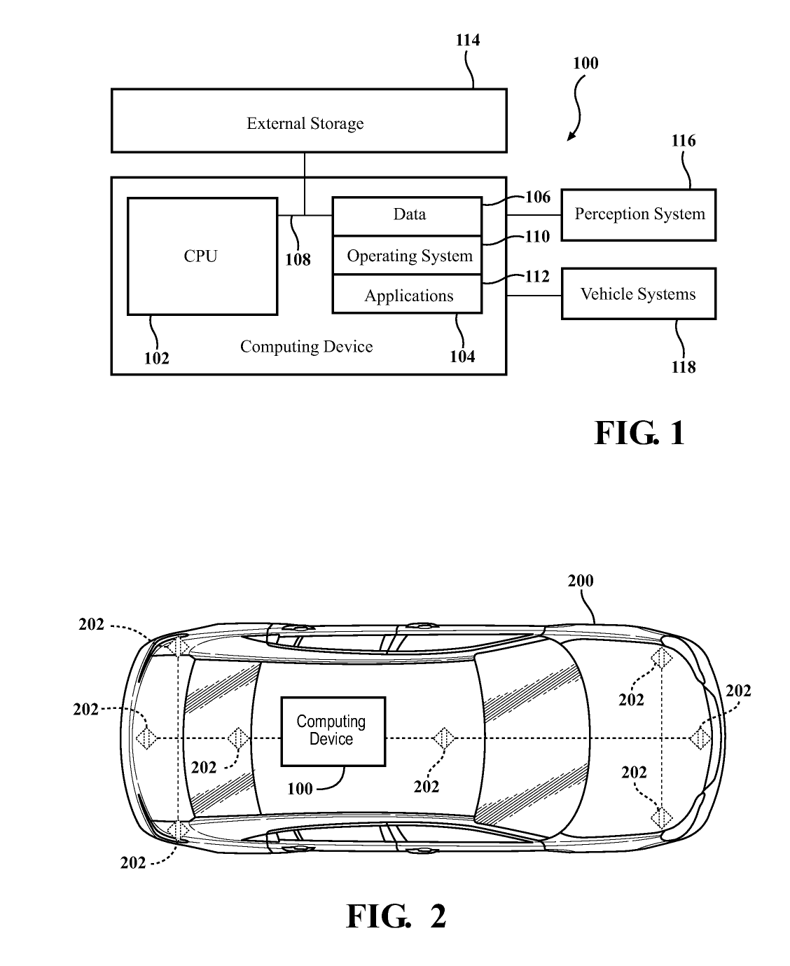

FIG. 1 is a block diagram of a computing device 100, for example, for use with an automated driving system. The computing device 100 can be any type of vehicle-installed, handheld, desktop, or other form of single computing device, or can be composed of multiple computing devices. The processing unit in the computing device can be a conventional central processing unit (CPU) 102 or any other type of device, or multiple devices, capable of manipulating or processing information. A memory 104 in the computing device can be a random access memory device (RAM) or any other suitable type of storage device. The memory 104 can include data 106 that is accessed by the CPU 102 using a bus 108.

The memory 104 can also include an operating system 110 and installed applications 112, the installed applications 112 including programs that permit the CPU 102 to perform the automated driving methods described below. The computing device 100 can also include secondary, additional, or external storage 114, for example, a memory card, flash drive, or any other form of computer readable medium. The installed applications 112 can be stored in whole or in part in the external storage 114 and loaded into the memory 104 as needed for processing.

The computing device 100 can be in communication with a perception system 116. The perception system 116 can be configured to capture data and/or signals for processing by an inertial measurement unit (IMU), a dead-reckoning system, a global navigation satellite system (GNSS), a light detection and ranging (LIDAR) system, a radar system, a sonar system, an image-based sensor system, or any other type of system capable of capturing information specific to the environment surrounding an autonomous vehicle. Information specific to the environment can include information specific to road geometry, traffic location, traffic rules, or to any other localized position data and/or signals that can be captured and sent to the CPU 102.

In the examples described below, the perception system 116 can be configured to capture, at least, images for an image-based sensor system such that the computing device 100 can detect a type of object of interest proximate to the autonomous vehicle, for example, an obstacle, a pedestrian, or a category of vehicle, the size of the object of interest, and/or the relative speed of any objects of interest within the images. The computing device 100 can also be in communication with one or more vehicle systems 118, such as a vehicle braking system, a vehicle propulsion system, a vehicle steering system, etc. The vehicle systems 118 can also be in communication with the perception system 116, the perception system 116 being configured to capture data indicative of performance of the various vehicle systems 118.

FIG. 2 is a schematic illustration of an autonomous vehicle 200 including the computing device 100 of FIG. 1. The computing device 100 can be located within the autonomous vehicle 200 as shown in FIG. 2 or can be located remotely from the autonomous vehicle 200 in an alternate location (not shown). If the computing device 100 is located remotely from the autonomous vehicle 200, the autonomous vehicle 200 can include the capability of communicating with the computing device 100.

The autonomous vehicle 200 can also include a plurality of sensors 202, the sensors 202 being part of the perception system 116 described in reference to FIG. 1. One or more of the sensors 202 shown can be configured to capture images for processing by an image sensor, vehicle position in global coordinates based on signals from a plurality of satellites, the distance to objects of interest within the surrounding environment for use by the computing device 100 to estimate position, orientation, and speed of the autonomous vehicle 200 and the objects of interest within the surrounding environment, or any other data and/or signals that can be used to determine the current state of the autonomous vehicle 200 or determine the current state of the surrounding environment including the presence of, position of, and speed of objects of interest proximate to the autonomous vehicle 200.

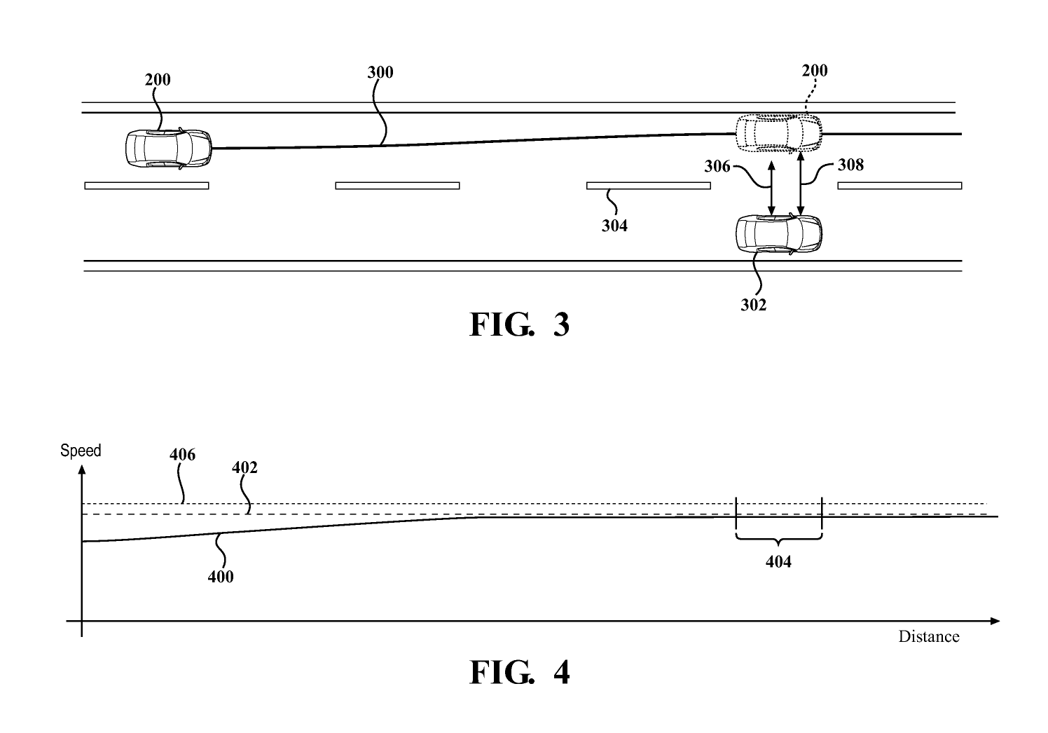

FIG. 3 shows a vehicle path 300 for the autonomous vehicle 200 of FIG. 2 proximate to another vehicle 302 in an adjacent lane. The sensors 202 disposed on the autonomous vehicle 200 can detect information specific to the environment surrounding the autonomous vehicle 200 and the vehicle 302. For example, the sensors 202 can detect the road geometry proximate to the vehicles 200, 302, in this case, that there are two lanes traveling in the same direction with a dotted line 304 separating the lanes. Based on this road geometry, and given the position and speed of the vehicle 302 in respect to the autonomous vehicle 200, the automated driving system can identify traffic rules, for example, that indicate that the autonomous vehicle 200 can safely pass the vehicle 302 while remaining within its current lane of travel.

The automated driving system can also be configured to determine a spacing or distance sufficient for driver comfort between the autonomous vehicle 200 and the vehicle 302 during a passing maneuver. In this example, sufficient spacing can be represented by a preferred gap 306, the preferred gap 306 being the distance between the autonomous vehicle 200 and the vehicle 302 that will allow for driver comfort. The distance selected for the preferred gap 306 can be based on the properties of the object of interest, for example, the type of object, the size of the object, and the relative speed of the object in reference to the autonomous vehicle 200. As the vehicle 302 in the example of FIG. 3 is a mid-sized passenger car traveling at a lower speed than the autonomous vehicle 200, the preferred gap 306 need not be overly large for driver comfort.

Selection of the preferred gap 306 can also be based on information specific to the environment surrounding the autonomous vehicle 200, such as road geometry, traffic location including a position and density of traffic in relation to the autonomous vehicle 200, and traffic rules. Selection of the preferred gap 306 can also be based on properties of the autonomous vehicle 200 such as the speed of the autonomous vehicle 200 and the level of autonomous operation. For example, if the passing maneuver indicated by the vehicle path 300 occurs at a low speed for both the autonomous vehicle 200 and the vehicle 302, the preferred gap 306 could be smaller than if the passing maneuver were to occur at higher levels of speed.

Once the vehicle path 300 is selected, the automated driving system can determine the actual gap 308 between the autonomous vehicle 200 and the vehicle 302 at the point where the autonomous vehicle 200 will pass the vehicle 302 on the vehicle path 300. In the example of FIG. 3, the actual gap 308 is larger than the preferred gap 306, that is, the autonomous vehicle 200 can travel the selected vehicle path 300 and maintain more than sufficient spacing for driver comfort during a passing maneuver. Based on the actual gap 308 being larger than the preferred gap 306, the automated driving system can determine a speed profile for the autonomous vehicle 200 along the vehicle path 300 as shown and described in FIG. 4.

FIG. 4 shows a speed profile 400 for the autonomous vehicle 200 of FIG. 2 along the vehicle path 300 of FIG. 3. The speed profile 400 is shown as a graph of vehicle speed over distance traveled by the autonomous vehicle 200. The graph indicates a target speed 402 for the autonomous vehicle 200 to reach before it passes the vehicle 302 at an indicated pass location 404. The target speed 402 is selected as part of the speed profile 400 by the automated driving system. The graph also indicates a maximum speed 406 that serves as a constraint on the speed profile 400 for consistency with traffic rules including speed limits for the location where the autonomous vehicle 200 is traveling. The speed profile 400 can be determined at the same time that the vehicle path 300 is determined since similar inputs, such as information specific to the environment, are used to determine the speed profile 400. Alternatively, the speed profile 400 can be determined after the vehicle path 300 is selected.

In the example of FIG. 4, the speed profile 400 shows that the autonomous vehicle 200 can increase its speed along the speed profile 400 in order to reach the target speed 402 slightly before it passes the vehicle 302 at the pass location 404. The target speed 402 selected is faster than the current speed of the autonomous vehicle 200 based at least in part on the actual gap 308 being larger than the preferred gap 306 at the pass location 404. The target speed 402 is also selected for consistency with traffic rules and driver comfort as a manually driven vehicle is often controlled to increase its speed to pass a slower moving vehicle so long as speed limits, such as the maximum speed 406, allow the increase in speed. The target speed 402 can also be selected based on the distance to any preceding vehicles and any constraints related to vehicle dynamics, that is, optimization of speed depends on the maneuver to be undertaken by the autonomous vehicle 200 and the environment surrounding the autonomous vehicle 200.

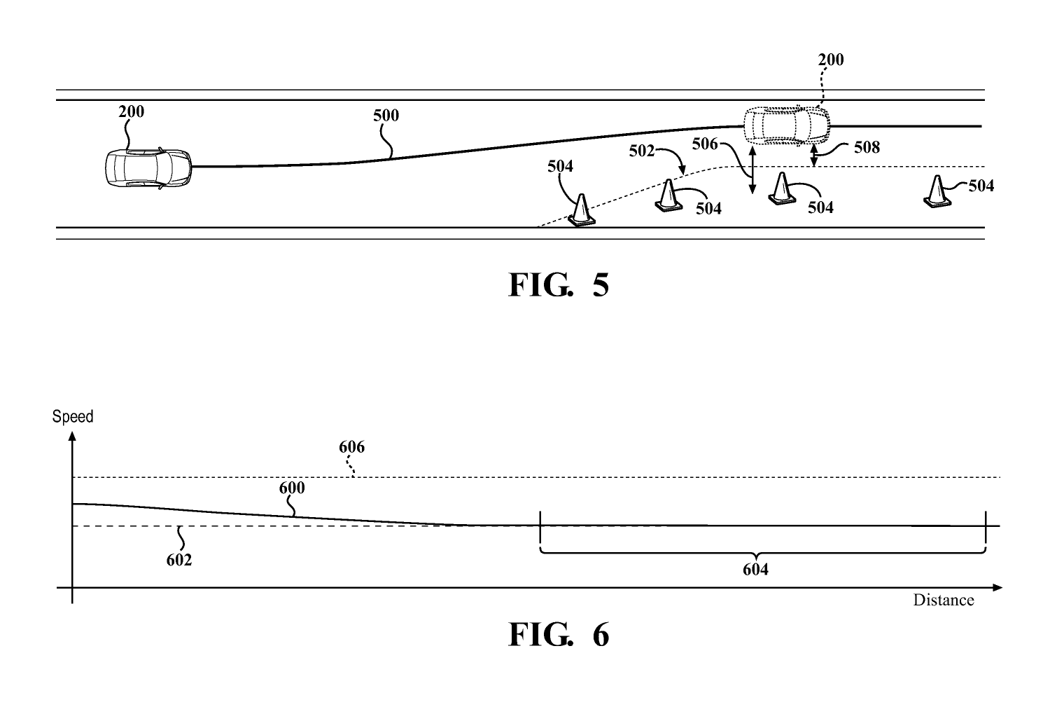

FIG. 5 shows a vehicle path 500 for the autonomous vehicle 200 of FIG. 2 proximate to a construction zone 502. Again, the sensors 202 disposed on the autonomous vehicle 200 can detect information specific to the environment surrounding the autonomous vehicle 200. For example, the sensors 202 can detect that the lane of travel includes multiple construction cones 504 in order to identify the upcoming construction zone 502. Based on the presence of the construction zone 502, the automated driving system can identify traffic rules, for example, that indicate that the autonomous vehicle 200 must lower its speed while within the construction zone 502.

In addition, the automated driving system can be configured to determine a spacing or distance sufficient for driver comfort between the autonomous vehicle 200 and the construction cones 504 during a passing maneuver. In this example, sufficient spacing can be represented by a preferred gap 506. Again, the distance selected for the preferred gap 506 can be based on the properties of the object of interest being passed, for example, the type of object, the size of the object, and the relative speed of the object in reference to the autonomous vehicle 200. As the object of interest in the example of FIG. 5 is a stationary construction zone 502 represented by multiple construction cones 504, the preferred gap 506 should be somewhat large both for driver comfort and for added safety of any construction workers that may be present within the construction zone 502.

Once the vehicle path 500 is selected, the automated driving system can determine the actual gap 508 between the autonomous vehicle 200 and the construction zone 502 at the point where the autonomous vehicle 200 will pass the construction zone 502 on the vehicle path 500. In the example of FIG. 5, the actual gap 508 is smaller than the preferred gap 506, that is, the autonomous vehicle 200 will not be able to maintain sufficient spacing for driver comfort along the selected vehicle path 500 while the autonomous vehicle 200 travels past the construction zone 502. Based on the preferred gap 506 being larger than the actual gap 508, the automated driving system can determine a speed profile for the autonomous vehicle 200 along the vehicle path 500 as shown and described in FIG. 6.

FIG. 6 shows a speed profile 600 for the autonomous vehicle 200 of FIG. 2 along the vehicle path 500 of FIG. 5. Again, the speed profile 600 is shown as a graph of vehicle speed over distance traveled and can be generated at the same time that the vehicle path 500 is determined or after the vehicle path 500 is determined. The graph includes a target speed 602 for the autonomous vehicle 200 to reach before it enters the construction zone 502 at the indicated construction location 604. The graph also includes a maximum speed 606 consistent with traffic rules. In the example of FIG. 6, the speed profile 600 shows that the autonomous vehicle 200 will decrease its speed along the speed profile 600 in order to reach the target speed 602 slightly before it enters the construction zone 502 at the construction location 604. The target speed 602 selected is slower than the current speed of the autonomous vehicle 200 based at least in part on the actual gap 508 at the construction location 604 being smaller than the preferred gap 506 selected for driver comfort. The target speed 602 is also selected for consistency with traffic rules as a manually driven vehicle would be required to decrease its speed upon entry into the construction zone 502 at the construction location 604.

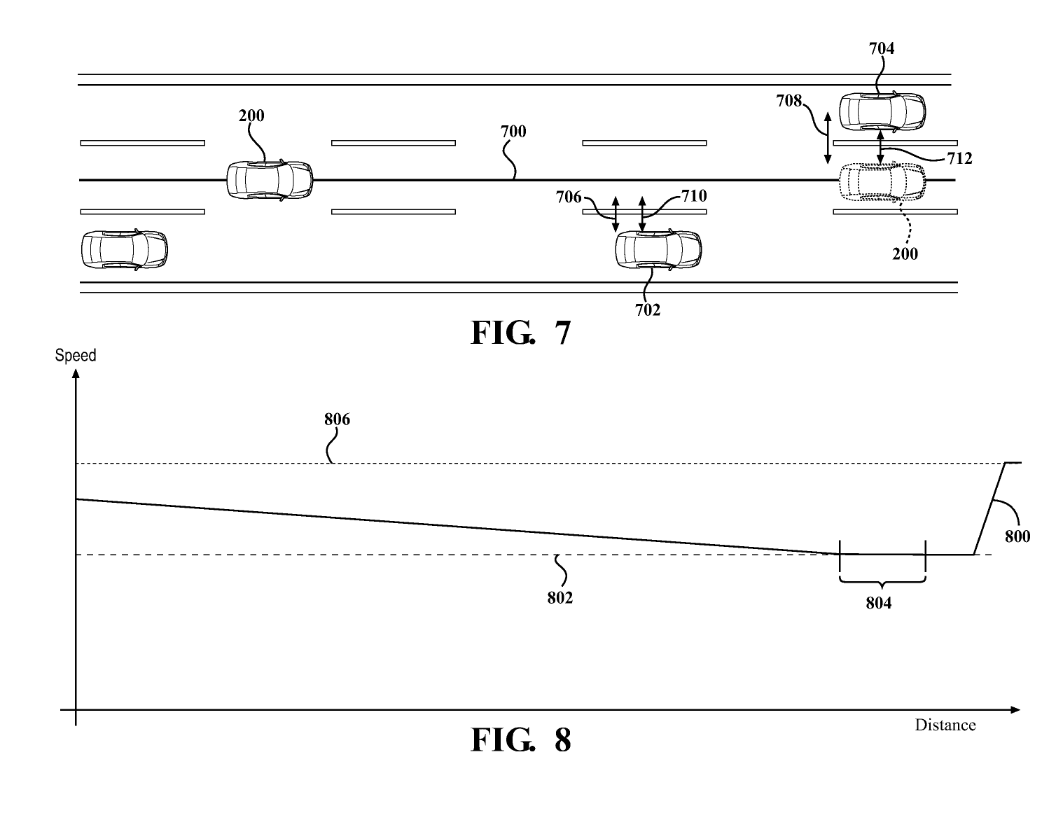

FIG. 7 shows a vehicle path 700 for the autonomous vehicle 200 of FIG. 2 proximate to a plurality of vehicles 702, 704 in adjacent lanes. Again, the sensors 202 disposed on the autonomous vehicle 200 can detect information specific to the environment surrounding the autonomous vehicle 200. For example, the sensors 202 can detect both a moving vehicle 702 on the right side of the autonomous vehicle 200 and a stopped vehicle 704 on the left side of the autonomous vehicle 200 as well as an upcoming intersection (not shown). Based on the presence of the vehicles 702, 704 and the structure of the upcoming intersection, the automated driving system can identify traffic rules, for example, that indicate that the autonomous vehicle 200 should lower its speed while passing the vehicle 704 and entering the intersection.

In addition, the automated driving system can be configured to determine a pair of preferred gaps 706, 708 sufficient for driver comfort between the autonomous vehicle 200 and the vehicles 702, 704 as the autonomous vehicle 200 approaches the intersection. In this example, the preferred gap 706 can be smaller than the preferred gap 708 because the vehicle 702 is moving at a similar speed to the autonomous vehicle 200 while the vehicle 704 is stopped in a turn lane before the intersection, so a higher relative speed exists between the autonomous vehicle 200 and the vehicle 704 than exists between the autonomous vehicle 200 and the vehicle 702. Also, the preferred gap 708 can be larger than the preferred gap 706 because the vehicle 704 is closer to the intersection than the vehicle 702, and traffic rules can dictate additional caution and hence slower speeds for the autonomous vehicle 200 once it nears the intersection.

Once the vehicle path 700 is selected, the automated driving system can determine the actual gaps 710, 712 between the autonomous vehicle 200 and the vehicles 702, 704 where the autonomous vehicle 200 will pass the vehicles 702, 704 on the vehicle path 700. In the example of FIG. 7, the actual gap 710 is the same size as the preferred gap 706, and the actual gap 712 is smaller than the preferred gap 708. Thus, though the autonomous vehicle 200 will be able to maintain sufficient spacing for driver comfort while passing the vehicle 702 along the selected vehicle path 700 without reducing speed, it will not be able to maintain sufficient spacing for driver comfort while passing the vehicle 704 near the intersection. Based primarily on the preferred gap 708 being smaller than the actual gap 712, the automated driving system can determine a speed profile for the autonomous vehicle 200 along the vehicle path 700 as shown and described in FIG. 8.

FIG. 8 shows a speed profile 800 for the autonomous vehicle 200 of FIG. 2 along the vehicle path 700 of FIG. 7. Again, the speed profile 800 is shown as a graph of vehicle speed over distance traveled and can be generated at the same time that the vehicle path 700 is determined or after the vehicle path 700 is determined. The graph includes a target speed 802 for the autonomous vehicle 200 to reach before it passes the vehicle 704 at the indicated pass location 804. Further, given the presence of the intersection beyond the vehicle 704, the speed profile remains at a lower speed until the autonomous vehicle 200 passes through the intersection. The graph also includes a maximum speed 806 consistent with traffic rules for the section of the road where the autonomous vehicle 200 is traveling.

In the example of FIG. 8, the speed profile 800 shows that the autonomous vehicle 200 will first decrease its speed in order to reach the target speed 802 before passing the vehicle 704 stopped at the intersection and will then increase its speed up to the maximum speed 806 after passing through the intersection. The target speed 802 selected is slower than the current speed of the autonomous vehicle 200 based on the actual gap 712 being smaller than the preferred gap 708 to the vehicle 704. The target speed 802 is also selected for consistency with traffic rules as a manually driven vehicle will often be controlled to decrease its speed before entering an intersection to conform to safe driving practices.

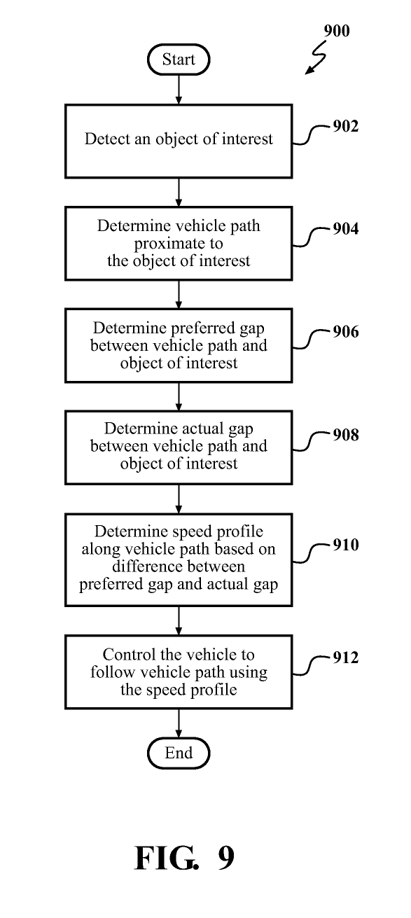

FIG. 9 is a logic flowchart of a gap and speed profile determination process 900 performed by the automated driving system. In step 902 of the process 900, the automated driving system can detect, using the sensors 202 associated with the perception system 116, an object of interest. The object of interest can have associated properties, such as type, size, and relative speed in relation to the autonomous vehicle 200. The object of interest type can be an obstacle, such as the construction cone 504 of FIG. 5, a pedestrian, or a vehicle category, such as a bicycle, a passenger car, a commercial vehicle, or an emergency vehicle. Both the size and the relative speed of the object of interest can affect calculations of a preferred gap between the autonomous vehicle 200 and the object of interest during a passing maneuver.

In step 904 of the process 900, the automated driving system can determine a vehicle path proximate to the object of interest, for example, vehicle paths 300, 500, and 700 shown in FIGS. 3, 5, and 7. The vehicle path can be selected based on information specific to the environment surrounding the autonomous vehicle 200. Information specific to the environment can include road geometry, such as lane structure, the presence of an intersection, etc. Information specific to the environment can also include information related to traffic location, that is, the position of adjacent vehicles and the density of traffic near the autonomous vehicle 200. Information specific to the environment can also include traffic rules, that is, traffic regulations to be followed by the autonomous vehicle 200 based on, for example, road geometry, speed limits, and the presence of adjacent vehicles.

In step 906 of the process 900, the automated driving system can determine a preferred gap between the vehicle path and the object of interest, such as preferred gaps 306, 506, and 708 in FIGS. 3, 5, and 7. The size of the preferred gap can be based on properties of the object of interest, such as the object of interest's size, type, or relative speed in relation to the autonomous vehicle 200. The size of the preferred gap can also be based on the information specific to the environment surrounding the vehicle, such as road geometry, traffic location, and traffic rules. For example, the preferred gap 306 between the autonomous vehicle 200 and the vehicle 302 in FIG. 3 is not very large, reflecting the simple lane geometry, the relative speed of the autonomous vehicle 200 as compared to the vehicle 302, that is, that the autonomous vehicle 200 is traveling faster than, but not significantly faster than, the vehicle 302, and the size and category of the vehicle 302, that is, a mid-size passenger car. Each of these properties indicate that a driver in the autonomous vehicle 200 would be relatively comfortable passing the vehicle 302 without a very large distance between the autonomous vehicle 200 and the vehicle 302.

In step 908 of the process 900, the automated driving system can determine an actual gap between the vehicle path and the object of interest, for example, actual gaps 308, 508, and 712 in FIGS. 3, 5, and 7. The actual gap is the distance that is projected to be present between the autonomous vehicle 200 and the object of interest at the point on the vehicle path where the autonomous vehicle 200 passes the object of interest.

In step 910 of the process 900, the automated driving system can determine a speed profile, such as speed profiles 400, 600, and 800 in FIGS. 4, 6, and 8, based at least in part on the difference between the preferred gap and the actual gap at the location of the object of interest. If the actual gap is larger than the preferred gap, as is shown in FIG. 3 by a comparison between the actual gap 308 and the preferred gap 306, the speed profile can be relatively unaffected by the gap, that is, the speed profile can be based instead on properties of the autonomous vehicle 200 such as speed and level of autonomous operation. However, if the actual gap is smaller than the preferred gap, as is the case in both FIGS. 5 and 7 with actual gaps 508 and 712 and preferred gaps 506 and 708, the speed profile can include a reduced speed for the autonomous vehicle 200 proximate to the object of interest in order to provide driver comfort.

In step 912 of the process 900, the automated driving system can send a command to one or more of the vehicle systems 118 to control the autonomous vehicle 200 to follow the vehicle path using the speed profile. For example, when the autonomous vehicle 200 follows the speed profile 800 of FIG. 8 along the vehicle path 700 of FIG. 7, the braking system can be controlled to decrease the speed of the autonomous vehicle 200 before the autonomous vehicle passes the vehicle 704 as shown in FIG. 7. Then, the engine control system can increase the speed of the autonomous vehicle 200 to the maximum speed 806 consistent with traffic rules after the autonomous vehicle 200 passes through the upcoming intersection. After step 912, the process 900 ends.

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims. The scope of the claims is to be accorded the broadest interpretation so as to encompass all such modifications and equivalent structures as is permitted under the law.

What is claimed is:

1. An automated driving system, comprising:
a perception system associated with an autonomous vehicle; and
a computing device in communication with the perception system, comprising:
one or more processors for controlling operations of the computing device; and
a memory for storing data and program instructions used by the one or more processors, wherein the one or more processors are configured to execute instructions stored in the memory to:
detect, using the perception system, an object of interest;
determine, based on information specific to an environment surrounding the autonomous vehicle, a vehicle path proximate to the object of interest;
determine, based on properties of the object of interest, a preferred gap between the vehicle path and the object of interest;
determine an actual gap between the vehicle path and the object of interest;
determine, based on a difference between the preferred gap and the actual gap, a speed profile for the autonomous vehicle along the vehicle path; and
send a command, to one or more vehicle systems, to control the autonomous vehicle to follow the vehicle path using the speed profile.

2. The automated driving system of claim 1, wherein the information specific to the environment surrounding the autonomous vehicle includes road geometry and traffic location and traffic rules.

3. The automated driving system of claim 1, wherein properties of the object of interest include type and size and relative speed in relation to the autonomous vehicle.

4. The automated driving system of claim 3, wherein the object of interest type is one of an obstacle and a pedestrian and a vehicle category.

5. The automated driving system of claim 1, wherein determining the preferred gap is further based on the information specific to the environment surrounding the autonomous vehicle.

6. The automated driving system of claim 1, wherein determining the preferred gap is further based on properties of the autonomous vehicle including autonomous vehicle speed and level of autonomous operation.

7. The automated driving system of claim 6, wherein determining the speed profile is further based on the properties of the object of interest and the properties of the autonomous vehicle.

8. The automated driving system of claim 1, wherein the speed profile includes a reduced speed for the autonomous vehicle proximate to the object of interest when the actual gap is smaller than the preferred gap.

9. A computer-implemented method of automated driving, comprising:
detecting, using a perception system associated with an autonomous vehicle, an object of interest;
determining, based on information specific to an environment surrounding the autonomous vehicle, a vehicle path proximate to the object of interest;
determining, based on properties of the object of interest, a preferred gap between the vehicle path and the object of interest;
determining an actual gap between the vehicle path and the object of interest;
determining, based on a difference between the preferred gap and the actual gap, a speed profile for the autonomous vehicle along the vehicle path; and
sending a command, to one or more vehicle systems, to control the autonomous vehicle to follow the vehicle path according to the speed profile.

10. The method of claim 9, wherein the information specific to the environment surrounding the autonomous vehicle includes road geometry and traffic location and traffic rules.

11. The method of claim 9, wherein properties of the object of interest include type and size and relative speed in relation to the autonomous vehicle and wherein the object of interest type is one of an obstacle and a pedestrian and a vehicle category.

12. The method of claim 9, wherein determining the preferred gap is further based on at least one of the information specific to the environment surrounding the autonomous vehicle and properties of the autonomous vehicle including autonomous vehicle speed and level of autonomous operation.

13. The method of claim 12, wherein determining the speed profile is further based on the properties of the object of interest and the properties of the autonomous vehicle.

14. The method of claim 9, wherein the speed profile includes a reduced speed for the autonomous vehicle proximate to the object of interest when the actual gap is smaller than the preferred gap.

15. A computing device, comprising:
one or more processors for controlling operations of the computing device; and
a memory for storing data and program instructions used by the one or more processors, wherein the one or more processors are configured to execute instructions stored in the memory to:
detect, using a perception system associated with an autonomous vehicle, an object of interest;
determine, based on information specific to an environment surrounding the autonomous vehicle, a vehicle path proximate to the object of interest;
determine, based on properties of the object of interest, a preferred gap between the vehicle path and the object of interest;
determine an actual gap between the vehicle path and the object of interest;
determine, based on a difference between the preferred gap and the actual gap, a speed profile for the autonomous vehicle along the vehicle path; and
send a command, to one or more vehicle systems, to control the autonomous vehicle to follow the vehicle path using the speed profile.

16. The computing device of claim 15, wherein the information specific to the environment surrounding the autonomous vehicle includes road geometry and traffic location and traffic rules.

17. The computing device of claim 15, wherein properties of the object of interest include type and size and relative speed in relation to the autonomous vehicle and wherein the object of interest type is one of an obstacle and a pedestrian and a vehicle category.

18. The computing device of claim 15, wherein determining the preferred gap is further based on at least one of the information specific to the environment surrounding the autonomous vehicle and properties of the autonomous vehicle including autonomous vehicle speed and level of autonomous operation.

19. The computing device of claim 18, wherein determining the speed profile is further based on the properties of the object of interest and the properties of the autonomous vehicle.

20. The computing device of claim 15, wherein the speed profile includes a reduced speed for the autonomous vehicle proximate to the object of interest when the actual gap is smaller than the preferred gap.
